(19) United States
(12) Patent Application Publication
(10) Pub. No.: US 2019/0289098 A1
(43) Pub. Date: Sep. 19, 2019

(54) REMOTE MANAGEMENT SYSTEM AND METHOD

(71) Applicant: Coretronic Corporation, Hsin-Chu (TW)

(72) Inventors: Jui-Chi Chen, Hsin-Chu (TW); Hung-Ru Lin, Hsin-Chu (TW)

(73) Assignee: Coretronic Corporation, Hsin-Chu (TW)

(21) Appl. No.: 16/352,790

(22) Filed: Mar. 13, 2019

(30) Foreign Application Priority Data
Mar. 16, 2018 (TW) 107108980

(51) Int. Cl. H04L 29/06; G06F 3/0484

(52) U.S. Cl. CPC H04L 67/38; G06F 3/04842

(57) ABSTRACT

A remote management system and a remote management method are provided. In the system, a network switcher transmits a network data flow. Signal conversion transceivers process conversions between an image signal and the network data flow and between a control signal and the network data flow. Each of a plurality of remote computers transmits the image signal including a display image via the corresponding signal conversion transceiver. A local apparatus displays at least one of the display images of the plurality of remote computers, and transmits the control signal including an input equipment control operation via the corresponding signal conversion transceiver to have the corresponding remote computer perform the input equipment control operation. A controller determines at least one of the remote computers to be monitored by the local apparatus.

### CROSS-REFERENCE TO RELATED APPLICATION

This application claims the priority benefit of Taiwan application serial no. 107108980, filed on Mar. 16, 2018. The entirety of the above-mentioned patent application is hereby incorporated by reference herein and made a part of this specification.

### BACKGROUND OF THE DISCLOSURE

### Field of the Disclosure

The disclosure relates to a remote manage technique, and in particular, to a remote management system and a remote management method based on network data flow transmission.

### Description of Related Art

Due to requirements for information security, equipment maintenance, convenience, etc., one or more system monitor centers are generally established in general large businesses, malls, or government agencies to monitor operations of remote servers. By connecting the remote servers via multiple keyboard-video-mouse switches (KVM switches), a manager can use a relatively small number of local apparatuses (e.g., a screen, a keyboard, a mouse, etc.) to remotely manage the remote servers, so that it is not necessary for the manager to go to the machine room to directly operate the remote servers.

In the related art, although the manager may also select different remote servers for control or monitor, or use different local apparatuses to perform operations, it is necessary to additionally dispose a control box to switch among images of different remote servers and the local apparatus, and it might even be necessary to manually operate a switch, which is inconvenient to the manager.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE DISCLOSURE

The embodiments of the disclosure provide a remote management system and a remote management method that allow a user to switch among remote servers in a more intuitive and convenient manner.

Other purposes and advantages of the embodiments of the disclosure may be further understood according to the technical features disclosed herein.

To achieve one, part, or all of the foregoing purposes or other purposes, a remote management system according to an embodiment of the disclosure includes a network switcher, a plurality of signal conversion transceivers, two remote computers, a local apparatus, and a controller. The network switcher transmits a network data flow. The signal conversion transceivers are connected to the network switcher and process conversions between an image signal and the network data flow and between a control signal and the network data flow. Each of the remote computers is connected to one signal conversion transceiver and transmits the image signal including a display image via the corresponding signal conversion transceiver. The local apparatus is connected to one signal conversion transceiver, displays at least one display image of the plurality of remote computers, and transmits the control signal including an input equipment control operation via the corresponding signal conversion transceiver to have the corresponding remote computer perform the input equipment control operation. The controller is connected to the network switcher and determines at least one of the plurality of remote computers to be monitored by the local apparatus.

In an embodiment of the disclosure, in the remote management system, the controller switches the remote computer currently monitored by the local apparatus to another remote computer in response to detecting, by the monitored remote computer, that a cursor displayed corresponding to the control signal being moved to a trigger area on the display image.

In an embodiment of the disclosure, the trigger area on the display image includes at least one image boundary.

In an embodiment of the disclosure, the remote computer determines a position of the at least one image boundary on the display image and detects whether the cursor is moved to the at least one image boundary.

In an embodiment of the disclosure, the monitored remote computer transmits a switch notification to the controller via the network switcher in response to detecting that the cursor being moved to the trigger area. The controller switches the remote computer currently monitored by the local apparatus to the another remote computer in response to reception of the switch notification.

In an embodiment of the disclosure, the controller transmits a switch command to the signal conversion transceiver connected to the local apparatus in response to reception of the switch notification; and the signal conversion transceiver connected to the local apparatus receives the display image of the another remote computer different from the currently monitored remote computer in response to reception of the switch command.

In an embodiment of the disclosure, the signal conversion transceiver connected to the local apparatus converts the display images of all of the remote computers into an image thumbnail to have the local apparatus display the image thumbnail. The image thumbnail displays the display images of the at least two remote computers according to an arrangement position, and the arrangement position is related to the trigger area of each of the remote computers.

In an embodiment of the disclosure, the trigger area of a first remote computer among the remote computers in the image thumbnail is adjacent to the display image of a second remote computer, and the controller switches the first remote computer currently monitored by the local apparatus to the second remote computer in response to detecting, by the first remote computer, that the cursor being moved to the trigger area.

In an embodiment of the disclosure, the remote computers provide a switch setting interface. The switch setting interface includes a selection setting of the remote computer according to the arrangement position, a position selection setting of the trigger area, and another selection setting of the remote computer corresponding to the trigger area.

In an embodiment of the disclosure, the remote computers include four of the remote computers, and the arrangement position is a 2×2 matrix arrangement of the display images associated with the four remote computers. Each of the remote computers includes two of the trigger area located on two sides in the display image thereof adjacent to the other display images.

To achieve one, part, or all of the foregoing purposes or other purposes, a remote management method according to an embodiment of the disclosure is adapted for a controller to control a local apparatus via a network switcher to manage one of at least two remote computers. The remote management method includes the following steps. The monitored remote computer receives a control signal including an input equipment control operation transmitted by the local apparatus to perform the input equipment control operation. The local apparatus displays a display image of the monitored remote computer. The controller switches the remote computer currently monitored by the local apparatus to another remote computer in response to detecting, by the monitored remote computer, that a cursor displayed corresponding to the control signal being moved to a trigger area on the display image.

In an embodiment of the disclosure, a multi-computer management program is stored in the remote computer and the remote computer executes the multi-computer management program, wherein the multi-computer management program is configured to determine whether the cursor controlled by the control signal is moved to the trigger area on the display image of the remote computer.

Accordingly, in the embodiments of the disclosure, the remote computer determines whether the cursor is moved to the trigger area to trigger the controller to perform the switch operation of the remote computers. Therefore, the user only needs to operate the cursor with a mouse or a touchpad to switch the controlled or monitored remote computer. Moreover, when the trigger area of the embodiments of the disclosure is set as the boundary of the display image, the display images of the other remote computers look like extension images of the display image displayed by one remote computer, so the operation is intuitive and simple.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a remote management system according to an embodiment of the disclosure.

FIG. 2 is a flowchart illustrating a remote management method according to an embodiment of the disclosure.

FIG. 3 is a schematic diagram illustrating a display image according to an embodiment of the disclosure.

FIG. 4 is a schematic diagram illustrating switching images according to an embodiment of the disclosure.

FIG. 5 is a schematic diagram illustrating a display image according to another embodiment of the disclosure.

FIG. 6 is a schematic diagram illustrating a thumbnail image with trigger areas as image boundaries according to an embodiment of the disclosure.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. Besides, the term “signal” may refer to at least one electric current, voltage, electric charge, temperature, data, electromagnetic wave or any other one or more signals.

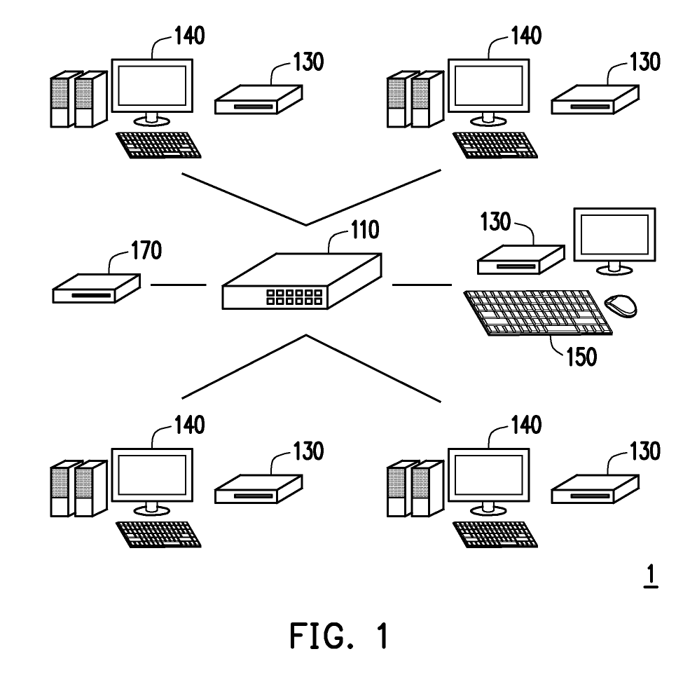

FIG. 1 is a schematic diagram illustrating a remote management system 1 according to an embodiment of the disclosure. Referring to FIG. 1, the remote management system 1 includes a network switcher 110, multiple signal conversion transceivers 130, multiple remote computers 140, a local apparatus 150, and a controller 170, but is not limited hereto.

The network switcher 110 may be a router or a switch supporting wired or wireless network technologies such as Ethernet and Wi-Fi, and forms a local area network (LAN) with other connection devices or is connected to the Internet. The network switcher 110 may transfer network data flows (e.g., IP (Internet Protocol) data flows, network packets, etc.) of one connection device to other connection devices based on network addresses.

For example, the signal conversion transceiver 130 is connected to the network switcher 110 via the local area network or signal lines, and the signal conversion transceiver 130 converts an image signal and a control signal into a network data flow. Specifically, the signal conversion transceiver 130 is configured to process conversions between the image signal and the network data flow and between the control signal and the network data flow. For example, the signal conversion transceiver 130 receives a network data flow from the network switcher 110 and identifies and converts the network data flow into an image signal (corresponding to a display image) or a control signal (corresponding to an input equipment control operation, e.g., moving a cursor, clicking on and selecting a shortcut, etc. by using a mouse or a touchpad, or inputting texts, numbers, etc. with a keyboard). Moreover, the signal conversion transceiver 130 receives an image signal or a control signal from the remote computer (e.g., a personal computer, a notebook computer, a tablet computer, etc.), converts the image signal or the control signal into a network data flow, and transmits the network data flow to the network switcher 110.

Each of the remote computers 140 is connected to one signal conversion transceiver 130 (namely, there are four signal conversion transceivers 130 respectively connected to four remote computers 140). One remote computer 140 is connected to the network switcher 110 via the signal conversion transceiver 130 to transmit the image signal and/or the control signal. The remote computer 140 may be an electronic device operated on various operating systems, such as a personal computer, a notebook computer, a tablet computer, etc. The remote computer 140 includes a display (e.g., a liquid-crystal display (LCD), a projection device, etc.), input equipment (e.g., a mouse, a keyboard, etc.), and a host (which includes, for example, a central processing unit (CPU) or a processor, and a storage device). The remote computer 140 generates an image signal according to a display image and transmits the image signal (packaged in the network data flow) including its display image to the network switcher 110 via the connected signal conversion transceiver 130. Moreover, the remote computer 140 receives a control signal from the network switcher 110 via the connected signal conversion transceiver 130 to perform an input equipment control operation (e.g., moving a mouse cursor, inputting texts, clicking on a shortcut, etc.) instructed by the control signal, which may be displayed on the display.

The local apparatus 150 is connected to one signal conversion transceiver 130 (namely, this signal conversion transceiver 130 is connected between the local apparatus 150 and the network switcher 110). The local apparatus 150 may include input equipment (e.g., a keyboard, a mouse, a touchpad, etc.) and a display, but is not limited hereto. In the embodiment, the input equipment of the local apparatus 150 may receive an input equipment control operation of a watcher and generate a control signal accordingly. The display of the local apparatus 150 is connected to the signal conversion transceiver 130 to receive the image signals from the remote computers 140 and display the display images.

The controller 170 is connected to the network switcher 110 and determines one of the remote computers 140 to be monitored by the local apparatus 150 or the multiple remote computers 140 to be simultaneously monitored. In other words, the controller 170 determines the display image and a user's input equipment control operation of one or more specific remote computers 140 to be displayed (or monitored) by the display of the local apparatus 150. Moreover, the controller 170 determines one of the remote computers 140 to be controlled by the input equipment control operation of the watcher that is received by the input equipment of the local apparatus 150.

It is noted that the numbers of the devices in FIG. 1 are exemplary and are merely intended to facilitate description of the embodiments. In the embodiments, the remote management system 1 includes at least two remote computers 140, and the remote computers 140 and the local apparatus 150 are each connected to one signal conversion transceiver 130. The numbers of other devices may be adjusted according to the actual requirement.

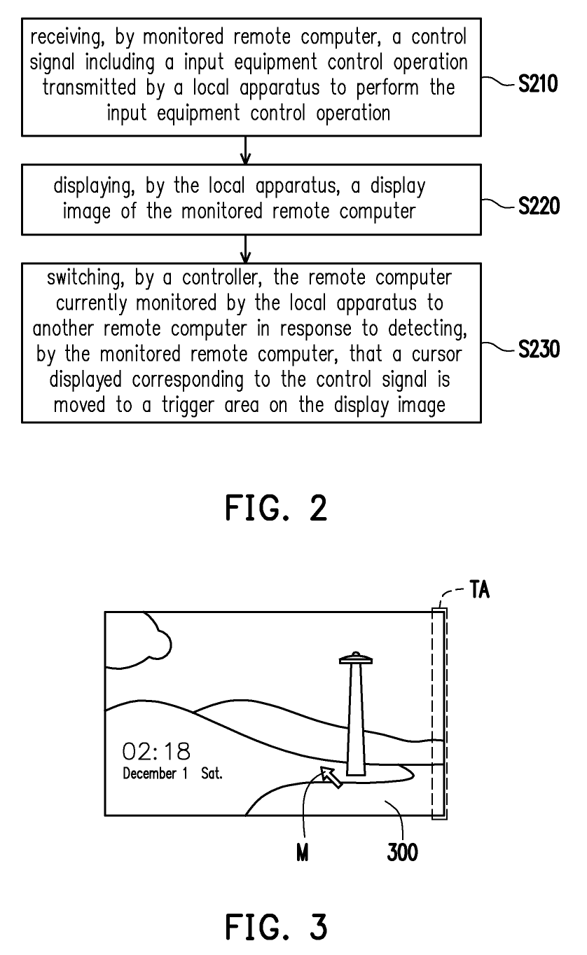

To facilitate understanding of operation procedures of the embodiments of the disclosure, multiple embodiments are described in detail below. FIG. 2 is a flowchart illustrating a remote management method according to an embodiment of the disclosure. Referring to FIG. 2, in the text below, the method of the embodiment is described with reference to the devices in FIG. 1. The procedures of the method may be adjusted according to implementation requirements and are not limited hereto.

The local apparatus 150 receives an input equipment control operation of a watcher via its input equipment to accordingly generate a control signal configured to instruct this input equipment control operation. Next, the connected signal conversion transceiver 130 converts the control signal into a network data flow, and the network switcher 110 receives the network data flow including the control signal. Then, the controller 170 dominates control (e.g., setting a destination address of the network data flow, setting a routing table of the network switcher 110, etc.) and is configured to switch to the remote computer 140 to be monitored. By receiving, via the monitored remote computer 140, the control signal including the input equipment control operation transmitted by the local apparatus 150, the monitored remote computer 140 can perform the input equipment control operation corresponding to the control signal according to the received control signal (step S210).

For example, the mouse of the local apparatus 150 receives an input equipment control operation that the watcher moves the mouse to move a cursor. The controller 170 controls a control signal for instructing moving the cursor to be transferred via the network switcher 110 to the signal conversion transceiver 130 connected to the assigned (monitored) remote computer 140. The assigned remote computer 140 obtains the control signal converted by the signal conversion transceiver 130, and then performs the operation of moving the cursor. Accordingly, the local apparatus 150 can control the monitored remote computer 140. It is noted that there may be many other types of the input equipment control operation, such as operations of clicking, function switching, inputting texts/numbers, etc. that may be received by any input equipment (e.g., a mouse, a keyboard, a touchpad, a trackball, etc.) The embodiments of the disclosure do not limit the type of the input equipment control operation.

On the other hand, each of the remote computers 140 generates an image signal including its display image. The image signal is converted into a network data flow by the connected signal conversion transceiver 130, and the network switcher 110 receives the network data flow including the image signal. Next, the controller 170 dominates control to receive the image signals of all or part of the remote computers 140 via the signal conversion transceiver 130 connected to the local apparatus 150 and have the display of the local apparatus 150 display the display image of the monitored remote computer 140 according to the image signal (step S220). For example, the local apparatus 150 displays the display image of one remote computer 140, or a combination of the display images of two or more of the remote computers 140, and the disclosure is not limited hereto.

It is noted that since the remote management system 1 is configured with two or more remote computers 140, to assist the watcher in managing the remote computers 140, each of the remote computers 140 is installed with a multi-computer management program. Specifically, the multi-computer management program is stored in the storage device of the host of the remote computer 140, and the processor of the host may execute the multi-computer management program. In the embodiment, the multi-computer management program determines whether the cursor controlled by the control signal is moved to a specific trigger area on the display image of the remote computer 140. The trigger area is related to switches among different remote computers 140 and will be detailed later.

Referring to FIG. 3, FIG. 3 shows a display image 300 of one remote computer 140. The display image 300 is simultaneously displayed on the display of the local apparatus 150. Specifically, the display image 300 of the remote computer 140 is mirrored to the display of the local apparatus 150, and the remote computer 140 determines whether a mouse cursor M is moved to a trigger area TA on the display image 300 (an input equipment control operation from the local apparatus 150). In an embodiment, to prevent a configuration position of the trigger area TA from affecting the input equipment control operation, the trigger area may be an image boundary. The remote computer 140 (host) first determines the position (e.g., coordinates and pixel positions of the display image) of the image boundary, and then detects whether a current position of the mouse cursor is overlapped with the position of the image boundary to confirm whether the mouse cursor is moved to the image boundary. It is noted that, in other embodiments, the trigger area may also be located at any other position (for example, at an image corner or on a specific icon or shortcut) on the display image, and a shape and a size of the trigger area may differ, which may be adjusted according to actual requirements of the user.

In response to detecting, by the monitored remote computer 140, that the mouse cursor displayed corresponding to the control signal being moved to the trigger area on the display image, the controller 170 switches the remote computer 140 currently monitored by the local apparatus 150 to another remote computer (step S230). Specifically, in response to detecting that the mouse cursor being moved to the trigger area, the monitored remote computer 140 generates a switch notification. After the switch notification is converted into a network data flow by the connected signal conversion transceiver 130, the switch notification is transmitted to the controller 170 via the network switcher 110. In response to reception of the switch notification, the controller 170 switches the remote computer 140 currently monitored by the local apparatus 150 to another remote computer 140.

In an embodiment, in response to reception of the switch notification, the controller 170 transmits a switch command to the signal conversion transceiver 130 connected to the local apparatus 150. In response to reception of the switch command, the signal conversion transceiver 130 connected to the local apparatus 150 receives the display image of another remote computer 140 different from the currently monitored remote computer 140 to have the display of the local apparatus 150 display the display image of the another remote computer 140.

In an embodiment, in response to reception of the switch notification, the controller 170 controls the signal conversion transceiver 130 connected to the currently monitored remote computer 140 to stop outputting the image signal, and controls the signal conversion transceiver 130 connected to another remote computer 140 to output the image signal to the local apparatus 150.

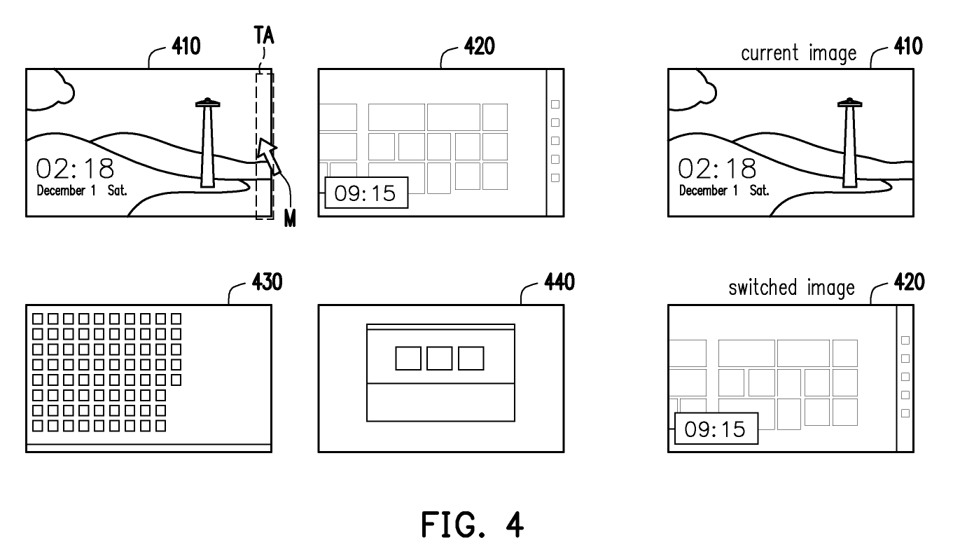

For example, referring to FIG. 4, on the left and in the middle of the figure are respectively display images 410 to 440 of four remote computers 140, and at the upper-right corner is a current image displayed by the display of the local apparatus 150, which by default is the display image 410 at the upper-left corner of the figure. When the remote computer 140 displaying the display image 410 detects movement of the mouse cursor M to the trigger area TA as instructed by the local apparatus 150, the remote computer 140 transmits a switch notification to the controller 170. The controller 170 controls the signal conversion transceiver 130 connected to the local apparatus 150 to have the display of the local apparatus 150 display the display image 420 (as shown by a switched image at the lower-right corner of FIG. 4) of another remote computer 140.

It is noted that, in some embodiments, when the controller 170 receives the switch notification, it may also control the signal conversion transceiver 130 of the local apparatus 150 to reduce the original display image to a specific proportion (e.g., reduced to 10%, 5%, 1%, etc. of the full screen image) and enlarge the display image of another remote computer 140 to a specific proportion (e.g., enlarged to 90%, 95%, 100%, etc. of the full screen image).

On the other hand, it is possible that the image displayed by the local apparatus 150 does not merely include the display image of one single remote computer 140 (e.g., on the right of FIG. 4). In an embodiment, the image displayed by the display of the local apparatus 150 includes a main display image (for example, occupying 80% or more of the full screen image and highlight displayed in a different frame color or with marking) and an auxiliary display image (for example, occupying 10% or less of the full screen image, displayed as semi-transparent, and being smaller than the main display image). The main display image includes the display image of the currently monitored remote computer 140, and the auxiliary display image may be the display image of the remote computer 140 that is not currently monitored, all of the remote computers 140, or the remote computer 140 to be switched to next. Moreover, the signal conversion transceiver 130 connected to the local apparatus 150 generates the main display image and the auxiliary display image according to the display images of all of the remote computers 140.

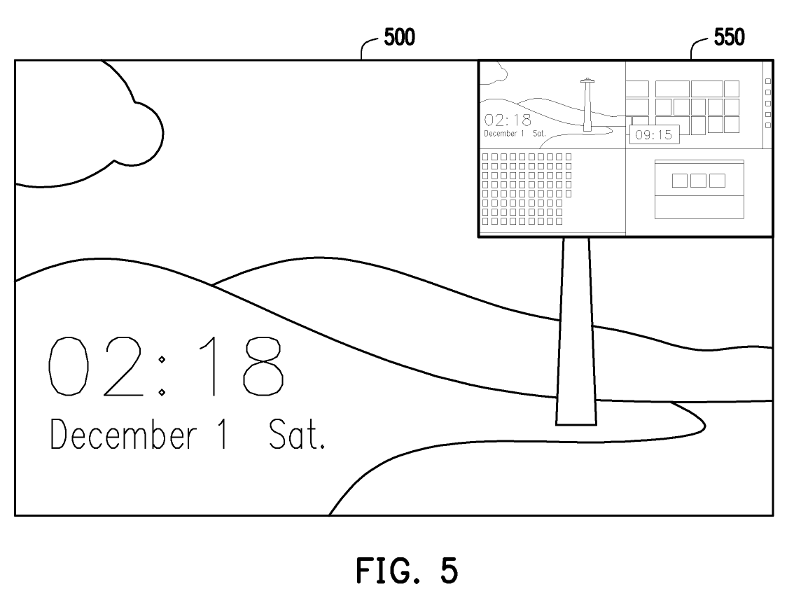

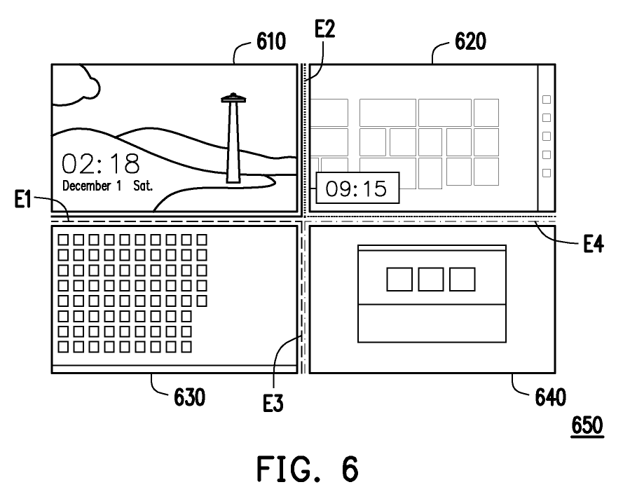

For example, referring to FIG. 5, FIG. 5 shows an image displayed by the local apparatus 150. The signal conversion transceiver 130 connected to the local apparatus 150 converts the display images of all of the remote computers 140 in the remote management system 1 into an image thumbnail 550 (i.e., the auxiliary display image) and transmits an image signal including the image thumbnail 550 to the local apparatus 150 to have the local apparatus 150 display the image thumbnail 550. The image thumbnail 550 occupies a part of a display image 500 (i.e., the main display image) of the local apparatus 150. The image thumbnail 550 displays the display images of the remote computers 140 according to a specific arrangement position (in a 2×2 matrix arrangement in the embodiment) and displays the display images of the four remote computers 140 in real time to assist the user in learning about all of the remote computers 140 that may be controlled. Moreover, the display image of the currently controlled remote computer 140 may be highlight displayed with texts, colors, marks, etc. in the image thumbnail 550 to assist the user in learning about the currently controlled remote computers 140.

It is noted that, in other embodiments, it is possible that the image thumbnail 550 only displays the display images of the current remote computer 140 and the remote computer 140 to be switched to next, or the image thumbnail 550 is displayed in another manner. In addition, the arrangement position may be presented in a 1×4 or 4×1 matrix, an annular shape, a sector, a specific geometric shape, or an irregular pattern, and people applying the embodiment shall be able to make adjustments according to the actual requirement. Furthermore, the image thumbnail 550 may be displayed on the display image 500 in response to an operation performed by the input equipment (e.g., a mouse, a keyboard, a button, etc.) of the local apparatus 150 on a specific shortcut key or virtual shortcut.

It is noted that the arrangement position of the image thumbnail described above may be relevant to the trigger areas of the remote computers 140. In an embodiment, the trigger area of a first remote computer 140 among the remote computers 140 in the image thumbnail is adjacent to the display image of a second remote computer 140. In response to detection, by the first remote computer 140, of movement of the cursor to the trigger area on its display image, the controller 170 switches the first remote computer 140 currently monitored by the local apparatus 150 to the second remote computer 140, such that the display of the local apparatus 150 mainly displays (for example, displayed in the full screen or 75% or more of the full screen image) the display image of the second remote computer 140 (namely, displayed as the main display image).

For example, referring to FIG. 6, FIG. 6 shows that the display of the local apparatus 150 displays an image thumbnail 650 encompassing all of the remote computers 140. The image thumbnail 650 includes display images 610 to 640 of four remote computers 140, and its arrangement position is a 2×2 matrix arrangement of the display images of the four remote computers 140. Each of the remote computers 140 includes two trigger areas (i.e., respective boundaries E1 to E4) located on two sides of the display images 610 to 640 adjacent to the other display images. The two image boundaries E1 of the display image 610 are adjacent to the display images 620 and 630. When the remote computer 140 displaying the display image 610 detects that the control signal instructed by the local apparatus 150 moves its mouse cursor to the image boundary E1 on the right side, the controller 170 controls the local apparatus 150 to display the display image 620. The two image boundaries E2 of the display image 620 are adjacent to the display images 610 and 640. When the remote computer 140 displaying the display image 620 detects that the control signal instructed by the local apparatus 150 moves its mouse cursor to the image boundary E2 on the lower side, the controller 170 controls the local apparatus 150 to display the display image 640. The rest of the switching scenarios may be analogously inferred and are not repeatedly described here. Accordingly, the user can clearly understand and select how to switch to the display image of the next remote computer 140.

It is noted that there may be many possibilities of the arrangement position of the display images in the image thumbnail, and there may be many variations of the position and shape/size of the trigger area. People applying the embodiment may make adjustments according to the actual requirements, as long as the configuration position of the trigger area in the image thumbnail is close or adjacent to the other display images, which thereby provides more intuitive and simple operation experience.

In addition, the multi-computer management program installed on the remote computers 140 may further provide a switch setting interface. The switch setting interface includes a selection setting of the remote computer 140 according to the arrangement position, a position selection setting of the trigger area, and another selection setting of the remote computer 140 corresponding to the trigger area. Taking FIG. 6 as an example, the selection setting of the remote computer 140 according to the arrangement position refers to the case that the image thumbnail 650 displays positions of the display images 610 to 640, and the remote computer 140 may receive a selection operation performed by the user on the positions in the image thumbnail 650 to determine which positions in the image thumbnail 650 display the display images of specific remote computers 140. The position selection setting of the trigger area refers to the user's setting of the trigger area on each of the display images 610 to 640. In the embodiment, the trigger area is the image boundaries E1 to E4. The selection setting of the remote computer 140 corresponding to the trigger area relates to the remote computer 140 to be switched to upon detection of the mouse cursor entering a specific trigger area. In some embodiments, after the selection setting of the remote computer 140 according to the arrangement position is completed, the remote computers 140 of the display images adjacent to the touch control area in the image thumbnail 650 may be already automatically determined, but the setting still allows the user to make changes according to the requirement. Accordingly, more flexible and diverse settings are provided.

It is noted that, in another embodiment, the switching sequence of the remote computers 140 may be predetermined. The controller 170 autonomously detects all of the connected remote computers 140 and then arranges them in order. Moreover, once one remote computer 140 detects presence of the mouse cursor on the trigger area of its display image, the controller 170 switches to the next remote computer 140 according to the switching sequence. There may be many other possibilities of the switching sequence of the remote computers 140, and people applying the embodiment may make adjustments according to the actual requirement.

In summary of the above, in the embodiments of the disclosure, the remote computers detect operations on the cursor performed by the local apparatus, and when the cursor is moved to the trigger area on the display image, the controller controls switch of the remote computer monitored by the local apparatus to another remote computer. Accordingly, the watcher only needs to operate the input equipment (e.g., a mouse, a touchpad, a trackball, etc.) to easily control the cursor to switch among the display images of different remote computers. Moreover, the local apparatus may display the display images of all of the remote computers in real time, which not only assists the user in learning about the currently controlled remote computer, but further enables the user to know how to switch to the remote computer to be controlled next.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A remote management system comprising:
a network switcher adapted to transmit a network data flow;
a plurality of signal conversion transceivers connected to the network switcher, each of the plurality of signal conversion transceivers processing conversions between an image signal and the network data flow and between a control signal and the network data flow;
a plurality of remote computers, each connected to the corresponding signal conversion transceiver and transmitting the image signal comprising a display image via the signal conversion transceiver;
a local apparatus connected to the corresponding signal conversion transceiver, displaying at least one of the display images of the plurality of remote computers, and transmitting the control signal comprising an input equipment control operation via the corresponding signal conversion transceiver to have the corresponding remote computer perform the input equipment control operation; and
a controller connected to the network switcher and determining at least one of the plurality of remote computers to be monitored by the local apparatus.

2. The remote management system according to claim 1, wherein the controller switches the remote computer currently monitored by the local apparatus to another remote computer in response to detecting, by the monitored remote computer, that a cursor displayed corresponding to the control signal being moved to a trigger area on the display image.

3. The remote management system according to claim 2, wherein the trigger area on the display image comprises at least one image boundary.

4. The remote management system according to claim 3, wherein the monitored remote computer determines a position of the at least one image boundary on the display image and detects whether the cursor is moved to the at least one image boundary.

5. The remote management system according to claim 2, wherein
the monitored remote computer transmits a switch notification to the controller via the network switcher in response to detecting that the cursor being moved to the trigger area, and
the controller switches the remote computer currently monitored by the local apparatus to the another remote computer in response to reception of the switch notification.

6. The remote management system according to claim 5, wherein
the controller transmits a switch command to the signal conversion transceiver connected to the local apparatus in response to reception of the switch notification, and
the signal conversion transceiver connected to the local apparatus receives the display image of the another remote computer different from the currently monitored remote computer in response to reception of the switch command.

7. The remote management system according to claim 2, wherein the signal conversion transceiver connected to the local apparatus converts the display images of at least two remote computers into an image thumbnail to have the local apparatus display the image thumbnail, wherein the image thumbnail displays the display images of the at least two remote computers according to an arrangement position, and the arrangement position is related to the trigger area of each of the at least two remote computers.

8. The remote management system according to claim 7, wherein the trigger area of a first remote computer among the corresponding at least two remote computers in the image thumbnail is adjacent to the display image of a second remote computer, and the controller switches the first remote computer currently monitored by the local apparatus to the second remote computer in response to detecting, by the first remote computer, that the cursor being moved to the trigger area.

9. The remote management system according to claim 7, wherein the at least two remote computers provide a switch setting interface, wherein the switch setting interface comprises a selection setting of the remote computer according to the arrangement position, a position selection setting of the trigger area, and another selection setting of the remote computer corresponding to the trigger area.

10. The remote management system according to claim 7, wherein the at least two remote computers comprise four of the remote computers, the arrangement position is a 2×2 matrix arrangement of the display images associated with the four remote computers, and each of the four remote computers comprises two of the trigger area located on two sides in the display image thereof adjacent to the other display images.

11. A remote management method, adapted for a controller to control a local apparatus via a network switcher to manage one of at least two remote computers, the remote management method comprising:
receiving, by the monitored remote computer, a control signal comprising an input equipment control operation transmitted by the local apparatus to perform the input equipment control operation;
displaying, by the local apparatus, a display image of the monitored remote computer; and
switching, by the controller, the remote computer currently monitored by the local apparatus to another remote computer in response to detecting, by the monitored remote computer, that a cursor displayed corresponding to the control signal being moved to a trigger area on the display image.

12. The remote management method according to claim 11, wherein the trigger area on the display image comprises at least one image boundary.

13. The remote management method according to claim 12, wherein after receiving, by the monitored remote computer, the control signal comprising the input equipment control operation transmitted by the local apparatus, the remote management method further comprises:
determining, by the monitored remote computer, a position of the image boundary on the display image; and
detecting, by the monitored remote computer, whether the cursor is moved to the at least one image boundary.

14. The remote management method according to claim 12, wherein after detecting, by the monitored remote computer, that the cursor displayed corresponding to the control signal being moved to the trigger area on the display image, the remote management method further comprises:
transmitting, by the monitored remote computer, a switch notification to the controller via the network switcher in response to detecting that the cursor being moved to the trigger area; and
switching, by the controller, the remote computer currently monitored by the local apparatus to the another remote computer in response to reception of the switch notification.

15. The remote management method according to claim 14, wherein the step of switching, by the controller, the remote computer currently monitored by the local apparatus to the another remote computer comprises:
transmitting, by the controller, a switch command to a signal conversion transceiver connected to the local apparatus in response to reception of the switch notification; and
receiving, by the signal conversion transceiver connected to the local apparatus, the display image of the another remote computer different from the currently monitored remote computer in response to reception of the switch command.

16. The remote management method according to claim 11, wherein the step of displaying, by the local apparatus, the display image of the monitored remote computer comprises:
converting, by the signal conversion transceiver connected to the local apparatus, the display images of the at least two remote computers into an image thumbnail to have the local apparatus display the image thumbnail, wherein the image thumbnail displays the display images of the at least two remote computers according to an arrangement position, and the arrangement position is related to the trigger area of each of the at least two remote computers.

17. The remote management method according to claim 16, wherein the trigger area of a first remote computer among the at least two remote computers in the image thumbnail is adjacent to the display image of a second remote computer, and the step of switching, by the controller, the remote computer currently monitored by the local apparatus to the another remote computer comprises:
switching, by the controller, the first remote computer currently monitored by the local apparatus to the second remote computer in response to detecting, by the first remote computer, that the cursor being moved to the trigger area.

18. The remote management method according to claim 16, further comprising:
providing, by the at least two remote computers, a switch setting interface, wherein the switch setting interface comprises a selection setting of the remote computer according to the arrangement position, a position selection setting of the trigger area, and another selection setting of the remote computer corresponding to the trigger area.

19. The remote management method according to claim 16, wherein the at least two remote computers comprise four of the remote computers, the arrangement position is a 2×2 matrix arrangement of the display images associated with the four remote computers, and each of the four remote computers comprises two of the trigger area located on two sides in the display image thereof adjacent to the other display images.

20. The remote management method according to claim 11, further comprising:
providing at least three signal conversion transceivers connected between the local apparatus and the network switcher and between the at least two remote computers and the network switcher; and
processing, by the at least three signal conversion transceivers, conversions between the image signal comprising the display image and a network data flow and between the control signal and the network data flow.

21. The remote management method according to claim 11, wherein the step of receiving, by the monitored remote computer, the control signal comprising the input equipment control operation transmitted by the local apparatus to perform the input equipment control operation comprises:
performing, by the monitored remote computer, the input equipment control operation according to the control signal to allow the local apparatus to control the monitored remote computer.

22. The remote management method according to claim 11, wherein a multi-computer management program is stored in the remote computer and the multi-computer management program is executed, wherein the multi-computer management program is configured to determine whether the cursor controlled by the control signal is moved to the trigger area on the display image of the remote computer.
